(19) United States
(12) Patent Application Publication
(10) Pub. No.: US 2007/0021139 A1
(43) Pub. Date: Jan. 25, 2007

(54) Radio communication system

(75) Inventors: Matthew P. J. Baker, Canterbury (GB); Timothy J. Moulsley, Catherham (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/561,995

(22) PCT Filed: Jun. 18, 2004
(86) PCT No.: PCT/IB04/02107

§ 371 Date: Dec. 23, 2005

(30) Foreign Application Priority Data
Jun. 28, 2003 (GB) 03151669
Aug. 19, 2003 (GB) 03194586

(51) Int. Cl. H04B 7/00; H04Q 7/20

(52) U.S. Cl. 455/522

(57) ABSTRACT

A mobile station (100), when performing soft handover between base stations (200), receives transmit power control commands from each base station (200). The mobile station (100) determines the reliability of each received transmit power control command by measuring its amplitude relative to a reliability threshold, and combines the power control commands to determine how to adjust its transmit power. The reliability threshold is dependent on the number of base stations (200), or the number of “up”and/or “down” commands received over a time period, or a function of a measured characteristic of received signals. Equivalently, instead of varying the threshold, the amplitude of the power control commands may be scaled, where the scaling factor is dependent on the number of base stations (200), or the number of “up” and/or “down” commands received over a time period, or a function of a measured characteristic of received signals. The reliability threshold, or scaling factor, may be different for commands from each different base station (200).

The invention relates to a radio communication system, a method of operating a radio communication system, and a mobile station for use in a radio communication system. While the present specification describes a system with particular reference to the Universal Mobile Telecommunication System (UMTS), the invention is also applicable to other mobile radio systems.

The current state of the art is described in the 3^{rd} Generation Partnership Project (3GPP) specifications for UMTS which are available at http://www.3gpp.org.

When a mobile station (in the UMTS specification referred to as a User Equipment (UE)) is in soft handover, it receives transmit power control (TPC) commands from each of the base stations (in the UMTS specification referred to as Node Bs) with which it is connected. The base stations with which the mobile station is connected are referred to as the mobile station's active set. Each base station generates Transmit Power Control (TPC) commands for each mobile station according to whether the received Signal to Interference Ratio (SIR) from the mobile station is above or below a target level: a “down” command, commanding the mobile station to reduce its transmit power, is transmitted to the mobile station if the received SIR is above the target, and an “up” command, commanding the mobile station to increase its transmit power, is transmitted to the mobile station if the received SIR is below the target. Consequently, in each timeslot a mobile station which is in soft handover may receive a variety of “up” and “down” commands from the different base stations in the active set. In each timeslot, the mobile station then combines these commands in order to make a decision as to whether to increase or decrease its transmit power.

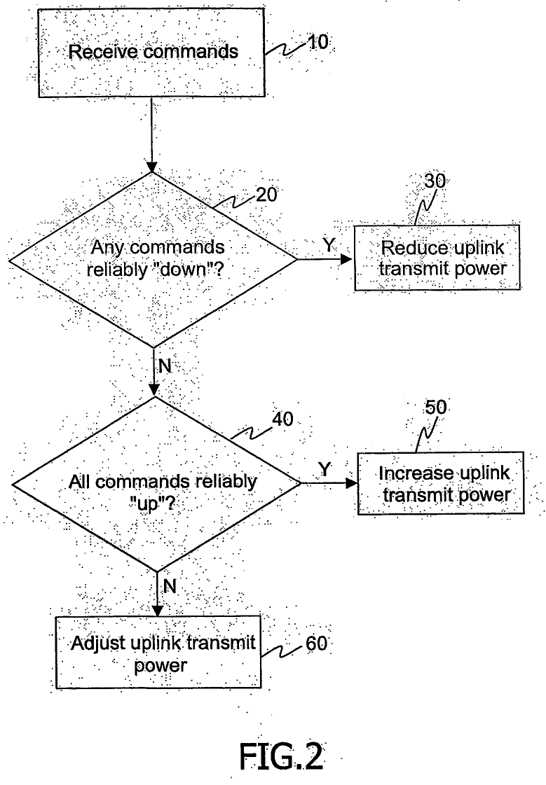

A flow diagram of the main specified requirements for this combining process for each time slot is shown in FIG. 2. At step 10, the mobile station receives power control commands from each base station and makes an assessment of the reliability of each command. The definition of reliability is not given in the UMTS specifications. One way of operating the mobile station is to derive the amplitude of each TPC command from soft values of one or more received bits comprising each TPC command. The amplitude of each received TPC command is then compared with a pre-determined threshold, and TPC commands whose amplitude magnitude is greater than the threshold are considered to be reliable. Note that the reliability thresholds for “up” commands and “down” commands are not necessarily the same; one method of operation is to consider all commands which are not “reliably down” to be “reliably up”. At step 20 in FIG. 2, the mobile station determines whether any of the TPC commands received in the current time slot are reliably “down”. If the answer is yes (Y), the mobile station reduces its transmit power at step 30. If the answer is no (N), flow proceeds to step 40 in which the mobile station determines whether all of the TPC commands received in the current time slot are reliably “up”. If the answer is yes (Y), the mobile station increases its transmit power at step 50. If the answer is no (N), the mobile may either increase or decrease its transmit power at step 60, meeting predetermined probabilities of increasing or decreasing its power.

An object of the invention is to provide improved power control during soft handover.

According to a first aspect of the present invention there is provided a mobile station for use in a radio communication system comprising a plurality of base stations, the mobile station comprising transmitter means, receiver means for receiving signals including transmit power control commands from the plurality of base stations, control means adapted to compare the amplitude of the received transmit power control commands with a reliability threshold and adapted to vary the transmit power of the transmitter means in response to the comparison, wherein the control means is further adapted to vary the reliability threshold according to a function of one or more of:

the number of base stations from which the mobile station receives transmit power control commands;

the number of commands to increase and/or decrease transmit power received in a preceding time period;

a measured characteristic of the signals received by the mobile station.

According to a second aspect of the present invention there is provided a radio communication system comprising a plurality of base stations and at least one mobile station, each base station having a receiver means for receiving signals from the mobile station and a transmitter means for transmitting signals including transmit power control commands to the mobile station, and the mobile station having transmitter means, receiver means for receiving signals including transmit power control commands from the plurality of base stations, control means adapted to compare the amplitude of the received transmit power control commands with a reliability threshold and adapted to vary the transmit power of the transmitter means in response to the comparison, wherein the control means is further adapted to vary the reliability threshold according to a function of one or more of:

the number of base stations from which the mobile station receives transmit power control commands;

the number of commands to increase and/or decrease transmit power received in a preceding time period;

a measured characteristic of the signals received by the mobile station.

According to a third aspect of the present invention there is provided method of operating a radio communication system comprising:

transmitting a signal from a mobile station;

receiving the signal at a plurality of base stations;

at each base station, in response to receiving the signal, deriving transmit power control commands and transmitting a signal comprising the transmit power control commands; and

at the mobile station, receiving the transmit power control commands from the plurality of base stations, comparing the amplitude of the received transmit power control commands with a reliability threshold, and adjusting the transmit power of the mobile station transmitter in response to the comparison, further comprising deriving the reliability threshold according to a function of one or more of:

the number of base stations from which the mobile station receives transmit power control commands;

the number of commands to increase and/or decrease transmit power received in a preceding time period;

a measured characteristic of the signals received by the mobile station.

According to a fourth aspect of the present invention there is provided a mobile station for use in a radio communication system comprising a plurality of base stations, the mobile station comprising transmitter means, receiver means for receiving signals including transmit power control commands from the plurality of base stations, control means adapted to compare the amplitude of the received transmit power control commands with a reliability threshold and adapted to vary the transmit power of the transmitter means in response to the comparison, wherein the control means is further adapted to scale by a scale factor the amplitude of the received transmit power control commands prior to the measurement, and wherein the control means is further adapted to vary the scale factor according to a function of one or more of:

the number of base stations from which the mobile station receives transmit power control commands;

the number of commands to increase and/or decrease transmit power received in a preceding time period;

a measured characteristic of the signals received by the mobile station.

According to a fifth aspect of the present invention there is provided a radio communication system comprising a plurality of base stations and at least one mobile station, each base station having a receiver means for receiving signals from the mobile station and a transmitter means for transmitting signals including transmit power control commands to the mobile station, and the mobile station having transmitter means, receiver means for receiving signals including transmit power control commands from the plurality of base stations, control means adapted to compare the amplitude of the received transmit power control commands with a reliability threshold and adapted to vary the transmit power of the transmitter means in response to the comparison, wherein the control means is further adapted to scale by a scale factor the amplitude of the received transmit power control commands prior to the measurement, and wherein the control means is further adapted to vary the scale factor according to a function of one or more of:

the number of base stations from which the mobile station receives transmit power control commands;

the number of commands to increase and/or decrease transmit power received in a preceding time period;

a measured characteristic of the signals received by the mobile station.

According to a sixth aspect of the present invention there is provided a method of operating a radio communication system comprising:

transmitting a signal from a mobile station;

receiving the signal at a plurality of base stations;

at each base station, in response to receiving the signal, deriving transmit power control commands and transmitting a signal comprising the transmit power control commands;

at the mobile station, receiving the transmit power control commands from the plurality of base stations, scaling by a scale factor the received transmit power control commands, comparing the amplitude of the scaled received transmit power control commands with a reliability threshold and adjusting the transmit power of the mobile station transmitter in response the comparison, further comprising deriving the scale factor according to a function of one or more of:

the number of base stations from which the mobile station receives transmit power control commands;

the number of commands to increase and/or decrease transmit power received in a preceding time period;

a measured characteristic of the signals received by the mobile station.

The invention is based on the realisation that a pre-determined threshold position, or equivalently a predetermined scale factor, is not suitable for all conditions and that the optimum position of the reliability threshold, or the optimum scale factor, is dependent on one or more of: the number of base stations in the active set; the proportion of commands previously decoded as “up” and “down”; and the received signal quality (e.g. SIR or average SIR) of the received TPC commands.

The fourth, fifth and sixth aspects of the invention are based on the realisation that an adaptively scaled signal in conjunction with a predetermined threshold can be equivalent to a non-scaled signal, or a signal scaled by a predetermined scale factor, in conjunction with an adaptive threshold. Furthermore, a combination of an adaptively scaled signal and an adaptive threshold can produce an equivalent result.

If the magnitude of the reliability threshold, or equivalently the scale factor, is adaptive according to a function of the number of base stations from which the mobile station receives power control commands, the magnitude of the reliability threshold may increase, or the scale factor decrease, (thus rendering more commands “unreliable”) for larger numbers of base stations in the active set and the magnitude of the reliability threshold may decrease, or the scale factor increase, (thus rendering more commands “reliable”) for smaller numbers of base stations in the active set.

If the magnitude of the reliability threshold, or equivalently the scale factor, is adaptive according to a function of the number of commands to increase and/or decrease transmit power received in a preceding time period, the magnitude of the reliability threshold may decrease, or the scale factor increase, (thus rendering more commands “reliable”) if more commands are decoded as “up” (increase transmit power) and the magnitude of the reliability threshold may increase, or the scale factor decrease, (thus rendering more commands “unreliable”) if more commands are decoded as “down” (decrease transmit power).

If the magnitude of the reliability threshold, or equivalently the scale factor, is adaptive according to a function of a measured characteristic of the received signals, such as SIR, the magnitude of the reliability threshold may decrease, or the scale factor increase, (thus rendering more commands “unreliable”) for lower values of received SIR and the magnitude of the reliability threshold may increase, or the scale factor decrease (thus rendering more commands “reliable”) for higher values of received SIR.

The measured characteristic of the signals received by the mobile station may be, for example, signal amplitude, signal to noise ratio, or signal to interference ratio.

The signals received by the mobile station from which the characteristics are measured may comprise transmit power control commands, or another signal such as a data bits or a pilot signal.

In one embodiment of the invention, the TPC bits may be transmitted at a higher power level than the accompanying data bits, although the power offset between the data bits and TPC bits is not known to the mobile station; in this case the magnitude of the reliability threshold may be set relative to the received amplitude of the data bits rather than the TPC or pilot bits. This ensures that the reliability threshold is not greater than the expected received amplitude of the TPC bits when the SIR is good, thus solving the problem that all TPC commands may be considered unreliable in the case when the mobile station does not know the value of the power offset between the data and the TPC bits.

A reliability threshold determined in accordance with the present invention may adopt different values for the different base stations in the active set in different timeslots.

The invention will now be described, by way of example only, with reference to the accompanying drawings wherein;

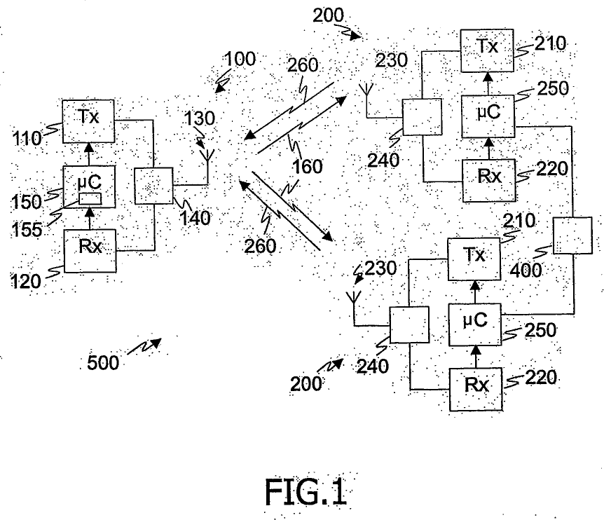

FIG. 1 is block schematic diagram of a radio communication system;

FIG. 2 is a flow chart illustrating the basic requirements for combining power control commands in soft handover in UMTS;

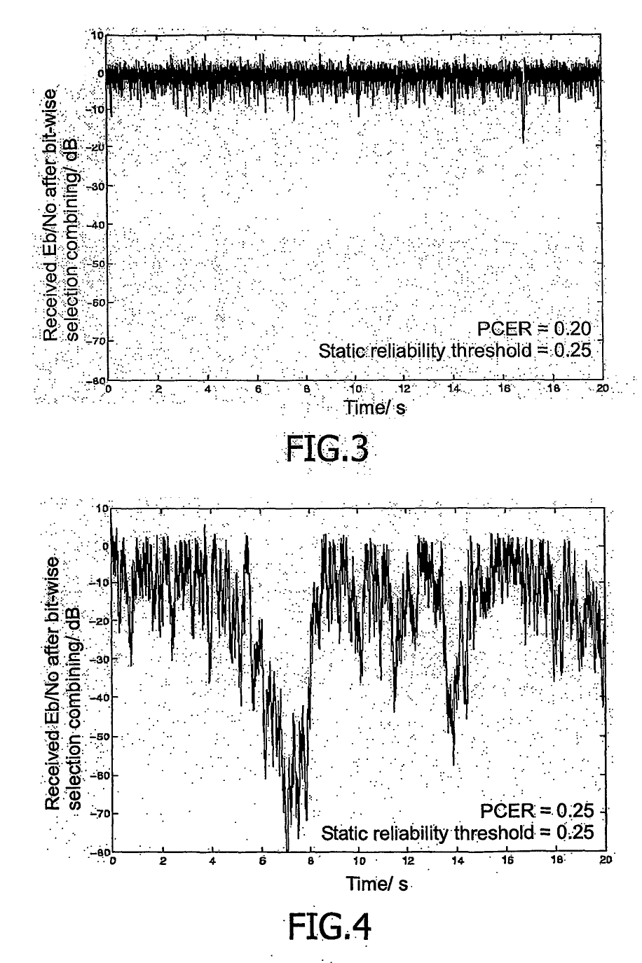

FIG. 3 is a graph showing the variation with time of the received signal to noise ratio of the power-controlled signal transmitted from the mobile station to three base stations in soft handover, after selection combining of the signals received by the three different base stations, when the mobile station uses a fixed reliability threshold of 0.25 for processing the TPC commands received from the base stations, and for a Power Control Error Ratio (PCER) (defined below) of 0.20.

FIG. 4 corresponds to FIG. 3, except for a PCER of 0.25.

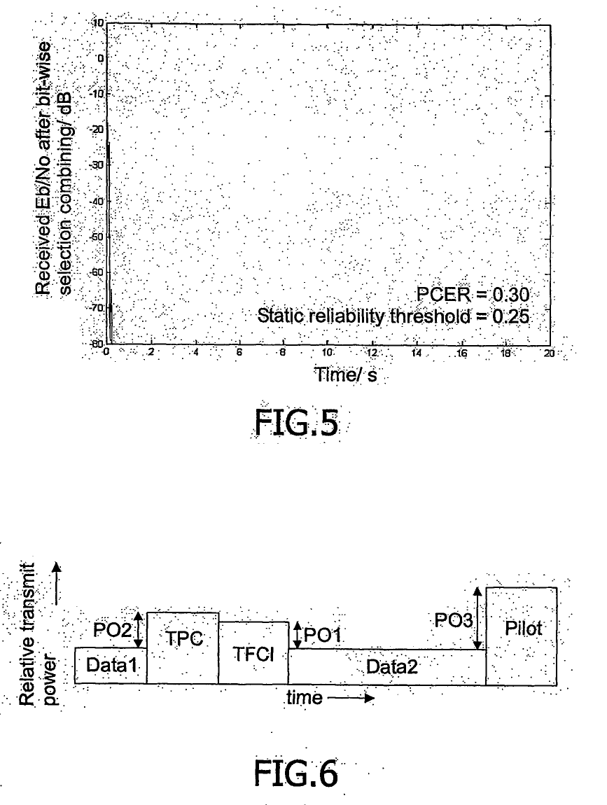

FIG. 5 corresponds to FIG. 3, except for a PCER of 0.30.

FIG. 6 is a diagram illustrating the power offsets between different fields in the downlink transmissions from a base station;

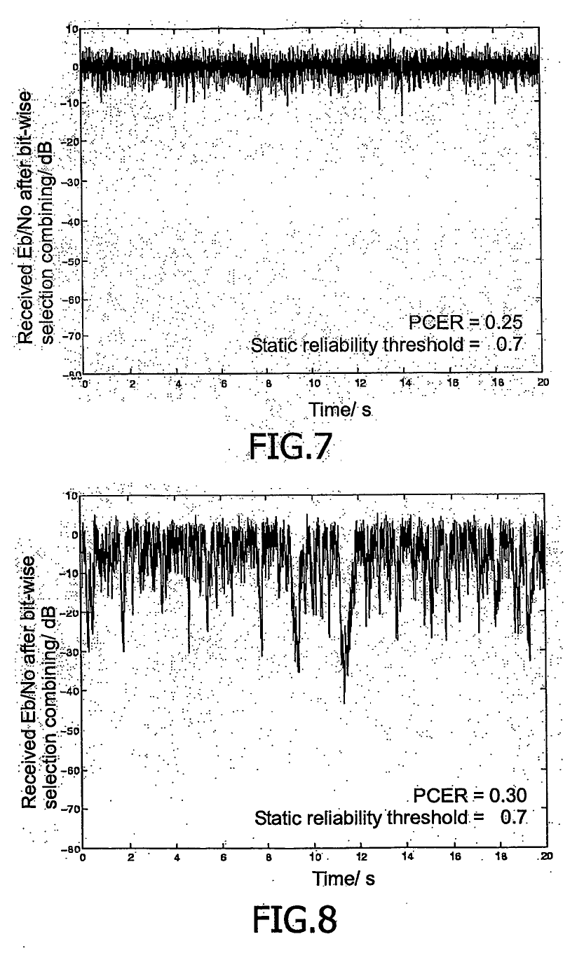

FIG. 7 is a graph showing the variation of signal to noise ratio with time after selection combining using a fixed threshold of 0.7 and a PCER of 0.25.

FIG. 8 is a graph showing the variation of signal to noise ratio with time after selection combining using a fixed threshold of 0.7 and a PCER of 0.30.

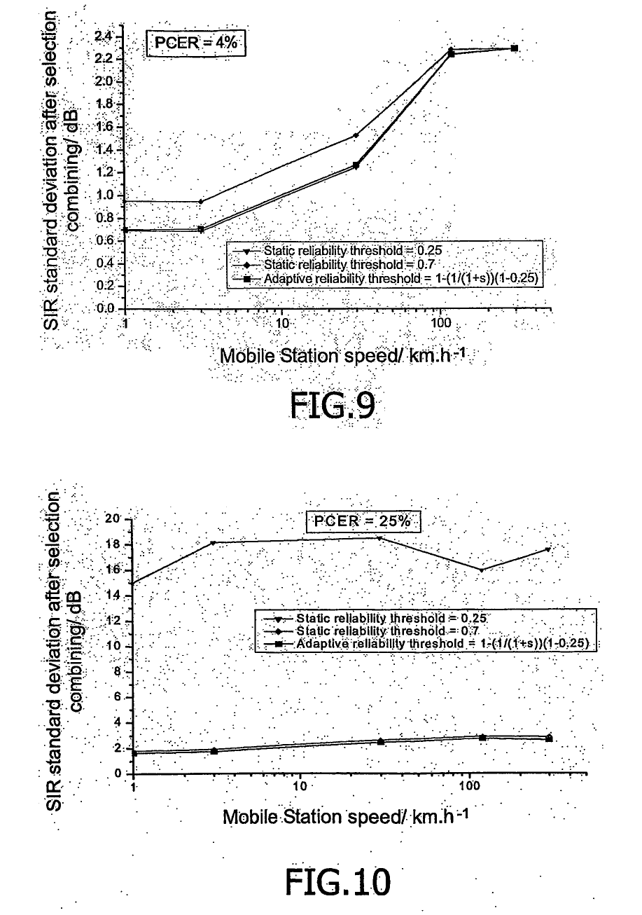

FIG. 9 is a graph illustrating the performance when using an adaptive reliability threshold for PCER=4%; and

FIG. 10 is a graph illustrating the performance when using an adaptive reliability threshold for PCER=25%.

Referring to FIG. 1 there is shown a radio communication system 500 comprising a mobile station 100 and two base stations 200l coupled via a fixed network 400. The mobile station 100 may be, for example, a portable telephone, or a wireless Personal Digital Assistant (PDA), or any other type of wireless equipped electronic device. The radio system 500 may comprise a plurality of the. mobile stations 100 and at least two of the base stations 200. The mobile station 100 comprises a transmitter means 110 and a receiver means 120. An output of the transmitter means 110 and an input of the receiver means 120 are coupled to an antenna 130 by a coupling means 140, which may be for example a circulator or a changeover switch. Coupled to the transmitter means 110 and receiver means 120 is a control means 150, which may be for example a processor. Each base station 200 comprises a transmitter means 210 and a receiver means 220. An output of the transmitter means 210 and an input of the receiver means 220 are coupled to an antenna 230 by a coupling means 240, which may be for example a circulator or a diplexer. Coupled to the transmitter means 210 and receiver means 220 is a control means 250, which may be for example a processor. The control means 250 processes messages received by the receiver means 220 and determines the messages transmitted by the transmitter means 210. The control means 250 is coupled to the fixed network 400. Transmission from the mobile station 100 to each base station 200 takes place on an uplink frequency channel 160 and transmission from the base stations 200 to the mobile station 100 takes place on a downlink frequency channel 260. In the following description it is assumed that the transmissions use spread spectrum techniques such that signals are spread using a spreading code, and data and control signals may be transmitted simultaneously with different spreading codes. However, such an assumption is not essential to the invention.

In operation, when the mobile station 100 is in soft handover, it can communicate with a plurality of base stations 200. The set of base stations 200 with which the mobile station 100 can communicate is termed the active set. The mobile station 100 transmits from its control means 150 via the transmitter means 110 a control signal to the active set of base stations 200. Each base station 200 receives the control signal via its receiver means 220. At each base station, the control means 250 determines whether the Signal to Interference Ratio (SIR) of the received control signal is above or below a target level, and issues a TPC command which is transmitted to the mobile station 100 by the base station transmitter means 220. A “down” command is transmitted if the received SIR is above the target and an “up” command is transmitted if the received SIR is below the target. Consequently, in each timeslot a mobile station 100 which is in soft handover may receive via the receiver means 110 a variety of “up” and “down” commands from the different base stations 200 in the active set. In each timeslot, the control means 150 of the mobile station 100 then combines these commands in order to make a decision as to whether to increase or decrease the uplink transmit power, and then generates a control signal which is used by the transmitter means 110 to adjust the transmit power according to the decision.

In order to make the decision, the reliability of each received TPC command is taken into account; the control means 150 includes a measurement means 155 for measuring the amplitude of each TPC command which it then compares against a reliability threshold, with TPC commands whose amplitude magnitude is greater than the threshold being considered to be reliable, and the other TPC commands being considered as unreliable.

The control means 150 adjusts the reliability threshold in response to a measurement of the received signals. In order to adjust the reliability threshold the control means 150 may either count the number of base stations 200 from which the mobile station 100 receives transmit power control commands, or count the number of transmit power control commands decoded as “up” and/or “down” in a time period, or measure a characteristic of a signal received by the mobile station. Such a measured characteristic may be, for example, signal amplitude, signal to noise ratio, or signal to interference ratio.

In the conditions where the SIR is relatively high, or the number of base stations in the active set is small, the optimal reliability threshold position is low, for example 0.25 relative to the expected received amplitude of the TPC commands. This results in most of the TPC commands being considered to be reliable.

In some embodiments it may be advantageous to ensure that the proportion of timeslots in which the mobile station reduces its transmit power is within a certain range, for example between 0.5 and 0.75. In such an embodiment, the mobile station may derive the proportion of downwards (or upwards) power changes during a preceding predetermined time period, and adjust the reliability threshold to keep the proportion of downwards or upwards power changes within the required range.

In the conditions where the SIR is relatively poor, or more base stations are in the active set, a higher reliability threshold position is needed, for example 0.7 in order to avoid instability arising from the requirement shown in FIG. 2 for the mobile station to reduce its transmitted power if any one of the TPC commands in the current slot are reliably “down”. In particular, if the received uplink SIR at all the base stations 200 in the active set is below their SIR targets, such that all base stations 200 in the active set transmit “up” commands, the poor SIR of the TPC commands will result in a high probability that at least one of the “up” commands will be received erroneously by the mobile station as a reliable “down” command, especially if the magnitude of the reliability threshold is low. Consequently, the transmitter means 110 of the mobile station 100 will continue to reduce its uplink transmit power, even though all the base stations 200 in the active set are requesting a power increase. This is illustrated in FIGS. 3,4 and 5, which show the received uplink E_{b}/N₀ (energy per bit divided by noise density) after selection combining between three base stations 200 in the active set, with a static reliability threshold of 0.25, and with a Power Control Error Ratio (PCER) of 0.2, 0.25 and 0.3 respectively. The PCER is a measure of the SIR of the TPC commands, and is defined as the proportion of TPC commands received as “up” when “down” was transmitted and vice versa, if a hard decision is taken against a zero threshold. Typical PCERs are generally considered to be in the range 4 to 10%, although this range could be as high as 30% in some situations in soft handover.

Note that for higher values of PCER, the transmit power of the mobile station 100 falls extremely rapidly (although in practice the depth of the fades would be limited by the dynamic range of the transmit power of the mobile station's transmitter 120).

This behaviour is highly undesirable, as the connection between the mobile station 100 and a base station 200 will be dropped as the uplink transmit power decreases, and this will become more likely the more base stations 200 there are in the active set.

The improvement resulting from using a higher reliability threshold of 0.7 in conditions where the SIR is relatively poor is illustrated in FIGS. 7 and 8 where it can be seen that the variability of the received SIR is much reduced relative to the variability exhibited in FIGS. 4 and 5 respectively.

The performance can also be improved by using a higher reliability threshold when there are more base stations in the active set, which makes it less likely that one TPC command in a slot will be decoded as reliably “down” when all the Node Bs in the active set transmitted “up” commands.

A single static value of the reliability threshold cannot give good performance in all conditions, and therefore in accordance with the invention the reliability threshold is adapted by the control means 150 according to a function of one or more of: the number of base stations in the active set; the proportion of commands which have previously been decoded as “up” or “down”; and the SIR of the received TPC commands. If the SIR of the received TPC commands is used in the adaptation of the reliability threshold, the SIR is measured by the measurement means 155.

A further problem with the current state of the art is that the mobile station 100 is not told in some releases of the UMTS specifications what transmit power offset is currently being used for the field containing the downlink TPC commands relative to the power of the downlink pilot bits. Referring to FIG. 6, the downlink TPC commands are transmitted at a power offset PO2 relative to the Downlink Dedicated Physical Data Channel (DPDCH), labelled Data1 and Data2 in FIG. 8. The other downlink control fields, Pilot and TFCI (Transport Format Combination Indicator), are transmitted at power offsets PO3 and PO1 respectively relative to the DPDCH. Each of PO1, PO2 and PO3 may take any value between 0 dB and +6 dB in 0.25 dB increments and may vary during a connection. However, only PO3 is signalled to the mobile station 100. This limits the mobile station's ability to position the reliability threshold in a suitable place.

In one embodiment of the invention, the reliability threshold is determined as

$${r}_{i}^{′} = {d}_{i} ( 1 - \frac{c}{c + s} ( 1 - t ) ) \qquad ( 1 )$$

where:

rᵢ′ is the magnitude of the reliability threshold for the i^{th} base station 200 in the active set;

dᵢ is the expected received amplitude of the data bits from the i^{th} base station 200, which may for example be derived from the measured pilot amplitude minus the power offset PO3;

s is a function of the inverse of the SIR on the received TPC commands, such as

$$s = \frac{Noise power}{Signal voltage} or s = \frac{1}{SIR} ;$$

c is an arbitrary constant; and

t a constant representing the minimum magnitude of the reliability threshold.

The presence of c in the denominator of equation (1) prevents the magnitude of the reliability threshold from ever becoming zero or negative. The signal voltage, noise power and/or SIR are estimated by the measurement means 155, for example from the received amplitudes of the TPC field, pilot field and/or data fields.

Various measures of the effectiveness of such an embodiment may be used. One such measure is the standard deviation of the resulting uplink E_{b}/N₀ after selection combining of the signals received by the various base stations 200 in the active set. Another such measure is the uplink E_{b}/N₀ required after selection combining in order to give a target Quality of Service (QoS), such as Bit Error Ratio (BER).

FIGS. 9 and 10 show that the present invention is highly effective in a wide range of situations. FIG. 9 shows that when the PCER=4% an adaptive reliability threshold can give performance (in terms of SIR standard deviation) as good as a low static reliability threshold. FIG. 10 shows that the same adaptive threshold formula gives performance as good as a high static reliability threshold when the PCER is much worse (25%).

Instead of adjusting the reliability threshold, the control means 150 may scale the received signals by an adjustable scale factor. Optionally a combination of the adjustments may be used.

Embodiments of the present invention have been described using spread spectrum Code Division Multiple Access (CDMA) techniques, as used for example in UMTS. However, the invention is not limited to use in CDMA systems. Similarly, although embodiments of the present invention have been described assuming frequency division duplex, the invention is not limited to use in such systems. It may also be applied to other duplex methods, for example time division duplex.

The functionality of the base station 100 may be distributed across a variety of fixed parts of a communications network. In this specification, the use of the term “base station” is therefore to be understood to include those parts of a communication network involved in an embodiment of the present invention.

From reading the present disclosure, other modifications will be apparent to persons skilled in the art. Such modifications may involve other features which are already known in radio communication systems and component parts thereof, and which may be used instead of or in addition to features already described herein.

In the present specification and claims the word “a” or “an” preceding an element does not exclude the presence of a plurality of such elements. Further, the word “comprising” does not exclude the presence of other elements or steps than those listed.

1. A mobile station (100) for use in a radio communication system (50) comprising a plurality of base stations (200), the mobile station (100) comprising transmitter means (110), receiver means (120) for receiving signals including transmit power control commands from the plurality of base stations (200), control means (150) adapted to compare the amplitude of the received transmit power control commands with a reliability threshold and adapted to vary the transmit power of the transmitter means (110) in response to the comparison, wherein the control means (150) is further adapted to vary the reliability threshold according to a function of one or more of:
the number of base stations (200) from which the mobile station (100) receives transmit power control commands;
the number of commands to increase and/or decrease transmit power received in a preceding time period;
a measured characteristic of signals received by the mobile station (100).

2. A mobile station (100) as claimed in claim 1, wherein the measured characteristic of signals received by the mobile station (100) is a measured characteristic of the received transmit power commands.

3. A mobile station as claimed in claim 1, wherein the control means is adapted to apply different reliability thresholds to the transmit power control commands received from the different base stations.

4. A radio communication system (50) comprising a plurality of base stations (200) and at least one mobile station (100), each base station (200) having a receiver means (220) for receiving signals from the mobile station (100) and a transmitter means (210) for transmitting signals including transmit power control commands to the mobile station (100), and the mobile station (100) having transmitter means (110), receiver means (120) for receiving signals including transmit power control commands from the plurality of base stations (200), control means (150) adapted to compare the amplitude of the received transmit power control commands with a reliability threshold and adapted to vary the transmit power of the transmitter means in response to the comparison, wherein the control means is further adapted to vary the reliability threshold according to a function of one or more of:
the number of base stations (200) from which the mobile station (100) receives transmit power control commands;
the number of commands to increase and/or decrease transmit power received in a preceding time period;
a measured characteristic of the signals received by the mobile station (100).

5. A radio communication system (50) as claimed in claim 4, wherein the control means (150) is adapted to apply different reliability thresholds to the transmit power control commands received from the different base stations (200).

6. A method of operating a radio communication system (50) comprising:
transmitting a signal from a mobile station (100);
receiving the signal at a plurality of base stations (200);
at each base station (200), in response to receiving the signal, deriving transmit power control commands and transmitting a signal comprising the transmit power control commands; and
at the mobile station (100), receiving the transmit power control commands from the plurality of base stations (200), comparing the amplitude of the received transmit power control commands with a reliability threshold, and adjusting the transmit power of a mobile station transmitter (110) in response to the comparison, further comprising deriving the reliability threshold according to a function of one or more of:
the number of base stations (200) from which the mobile station (100) receives transmit power control commands;
the number of commands to increase and/or decrease transmit power received in a preceding time period;
a measured characteristic of the signals received by the mobile station (100).

7. A method as claimed in claim 6, comprising applying different reliability thresholds to the transmit power control commands received from the different base stations (200).

8. A mobile station (100) for use in a radio communication system (50) comprising a plurality of base stations (200), the mobile station (100) comprising transmitter means (110), receiver means (120) for receiving signals including transmit power control commands from the plurality of base stations (200), control means (150) adapted to compare the amplitude of the received transmit power control commands with a reliability threshold and adapted to vary the transmit power of the transmitter means in response to the comparison, wherein the control means (150) is further adapted to scale by a scale factor the amplitude of the received transmit power control commands prior to the measurement, and wherein the control means is further adapted to vary the scale factor according to a function of one or more of:
the number of base stations (200) from which the mobile station (100) receives transmit power control commands;
the number of commands to increase and/or decrease transmit power received in a preceding time period;
a measured characteristic of the signals received by the mobile station (100).

9. A mobile station (100) as claimed in claim 8, wherein the measured characteristic of signals received by the mobile station (100) is a measured characteristic of the received transmit power commands.

10. A mobile station (100) as claimed in claim 8, wherein the control means (150) is adapted to apply different reliability thresholds to the transmit power control commands received from the different base stations (200).

11. A radio communication system (50) comprising a plurality of base stations (200) and at least one mobile station (100), each base station (200) having a receiver means (220) for receiving signals from the mobile station (100) and a transmitter means (210) for transmitting signals including transmit power control commands to the mobile station (100), and the mobile station (100) having transmitter means (110), receiver means (120) for receiving signals including transmit power control commands from the plurality of base stations (200), control means (150) adapted to compare the amplitude of the received transmit power control commands with a reliability threshold and adapted to vary the transmit power of the transmitter means in response to the comparison, wherein the control means is further adapted to scale by a scale factor the amplitude of the received transmit power control commands prior to the measurement, and wherein the control means (150) is further adapted to vary the scale factor according to a function of one or more of:
the number of base stations (200) from which the mobile station (100) receives transmit power control commands;
the number of commands to increase and/or decrease transmit power received in a preceding time period;
a measured characteristic of the signals received by the mobile station (100).

12. A radio communication system (50) as claimed in claim 11, wherein the control means (150) is adapted to apply different reliability thresholds to the transmit power control commands received from the different base stations (200).

13. A method of operating a radio communication system (50) comprising:
transmitting a signal from a mobile station (100);
receiving the signal at a plurality of base stations (200);
at each base station (200), in response to receiving the signal, deriving transmit power control commands and transmitting a signal comprising the transmit power control commands;
at the mobile station (100), receiving the transmit power control commands from the plurality of base stations (200), scaling by a scale factor the received transmit power control commands, comparing the amplitude of the scaled received transmit power control commands with a reliability threshold and adjusting the transmit power of the mobile station transmitter in response the comparison, further comprising deriving the scale factor according to a function of one or more of:
the number of base stations (200) from which the mobile station (100) receives transmit power control commands;
the number of commands to increase and/or decrease transmit power received in a preceding time period;
a measured characteristic of the signals received by the mobile station (100).

14. A method as claimed in claim 13, comprising applying different reliability thresholds to the transmit power control commands received from the different base stations (200).
